(19) United States
(12) Patent Application Publication
(10) Pub. No.: US 2016/0267440 A1
(43) Pub. Date: Sep. 15, 2016

(54) LOCATION AND ACTIVITY BASED EVENT PLANNING METHOD AND SYSTEM

(71) Applicant: Rage Life LLC, Denver, CO (US)

(72) Inventor: Michael A. LeBeau, Denver, CO (US)

(21) Appl. No.: 15/068,531

(22) Filed: Mar. 11, 2016

Related U.S. Application Data
(60) Provisional application No. 62/132,899, filed on Mar. 13, 2015.

(51) Int. Cl. G06Q 10/10; G06Q 50/00

(52) U.S. Cl. CPC G06Q 10/1095; G06Q 50/01

(57) ABSTRACT

A method of organizing events based on real-time location information is disclosed. The method includes receiving a search radius, determining a current location of a user device based on real-time location information, and receiving location information associated with an event specifying a location of the event. The method further includes determining whether a distance between the current location of the user device and the location of the event exceeds the search radius and responsive to determining that the distance between the current location of the user device and the location of the event does not exceed the search radius, displaying information associated with the event on a display of the user device.

### CROSS REFERENCE TO RELATED APPLICATIONS

This application claims priority to U.S. Provisional Patent Application No. 62/132,899 entitled LOCATION AND/OR ACTIVITY BASED EVENT PLANNING METHOD AND SYSTEM filed Mar. 13, 2015, which is incorporated herein by reference for all purposes.

### BACKGROUND

The Internet has opened up lines of communication and created the potential to expand social networks beyond what previously existed. While many of these expanded social networks exist entirely in cyberspace, many people wish to use the convenience of the Internet to expand and facilitate their real-world social networks. To that end, the Internet may be used as a tool to create and share events with the goal of developing new relationships with people outside of the confines of the Internet. Many persons have interests that they wish to share and participate in with others that cannot be facilitated by the Internet, such as sports, board games, food and beverage enthusiasm, etc. These activities are inherently physical, and therefore cannot exist solely across a virtual medium.

### SUMMARY

In one embodiment, the present disclosure is directed to a method for notifying users of events, creating events, and/or registering users for events. In one implementation, the method notifies users of one or more events based on distance. For example, the method includes receiving a search radius, determining, by one or more processors, a current location of a user, based at least on GPS information, receiving location information for one or more events specifying a location of the event, determining whether a distance between the current location of the user and the location of the event exceeds the search radius, if the distance falls within the search radius, displaying information associated with the event to the user.

In another implementation, the method uses a user chosen category, such as a particular activity type, to dynamically select events to display to a user. In this method, events may be displayed to a user that fall within the chosen category or categories.

In yet another embodiment, an event creator schedules an event and designates a location and activity type or types associated with the event. A user sets an event search radius and designates activity types in which they are interested. The user's activity feed is dynamically populated with the event if the event location falls within the user's search radius and the event has an activity type designated by the user.

In still another embodiment, a method for categorizing events is provided in which a predetermined set of activity types is provided to which an event may be assigned. If the event does not match any of the predetermined activity types, the event can be assigned to a wildcard category (or other miscellaneous category type or name). In some embodiments, all users are designated to receive wildcard activities in the users' activity feeds, unless the wildcard category is deselected by the users. However, in other embodiments, the wildcard category is configured so that it cannot be selected or deselected by a user such that it forms a default activity category to populate across the activity feed for all users.

Other methods and systems are envisioned and the above examples are meant as illustrative only.

### BRIEF DESCRIPTION OF THE DRAWINGS

FIG. 1 is a block diagram of a distributed computing system including a location-based event planning program.

FIG. 2 is a flowchart depicting operations for displaying events based on real-time location information.

FIG. 3 is a flowchart depicting operations for selecting an event based on real-time location information.

FIG. 4 is a flowchart depicting operations for creating an event.

FIG. 5 is a flowchart depicting operations for electronically transferring cost of attendance fees through the location based event planning program.

FIG. 6 is a flowchart depicting operations for creating an event in a location based event planning program with an associated cost of attendance.

FIG. 7 is a functional block diagram depicting components of a programmable electronic device on which the location-based event planning program may be executed.

FIG. 8 illustrates an exemplary display of a profile creation screen for an event planning program.

FIG. 9 illustrates an exemplary activity selection page for display on a user device.

FIG. 10 illustrates an exemplary activity feed for display on a user device.

FIG. 11 illustrates an exemplary display of an activity type selection page for event creation.

FIG. 12 illustrates an exemplary display of an event creation screen.

FIG. 13 illustrates an exemplary display of an event page.

FIG. 14 illustrates an exemplary display of the chat or messaging screen.

FIG. 15 illustrates an exemplary display of a list of attendees associated with an event.

FIG. 16 illustrates an exemplary display of a map for an event.

FIG. 17 illustrates an exemplary display of a menu screen of an event planning program.

FIG. 18 illustrates an exemplary display of an edit activity selections screen.

FIG. 19 illustrates an exemplary display of a settings screen.

FIG. 20 illustrates an exemplary about screen.

FIG. 21 illustrates an exemplary user profile page.

FIG. 22 illustrates an exemplary edit user profile display.

FIG. 23 illustrates a second exemplary display of an event page.

FIG. 24 illustrates an exemplary event list.

### DETAILED DESCRIPTION

Embodiments disclosed herein are directed to location and/or activity based event planning. One of the challenges in using the Internet to facilitate physical gatherings is the barrier of distance. The Internet allows for near instantaneous communication across the world and, therefore, has little consideration for the physical location of its users. However, when using the Internet to facilitate real-world gatherings, the relative locations of the participants and the location of the event become primary concerns. For instance, it is likely not practical for a person who lives in London to travel to Colorado for an afternoon of skiing. Certain communities may be centered on a particular city, town, or region, but such distinctions are limiting if a person leaves that specified region. For example, a person living in Boston may participate in a community that informs her of activities taking place in and around the Boston Metro Area, but this community is of little use while the person is on vacation in Seattle. Accordingly, disclosed herein are various methods, computer program products, and systems for providing real-time, location-based event information.

Various embodiments described herein provide a user with the ability to view, create, access, edit, and/or RSVP to various real-world events based on real-time location information of the user. Embodiments allow a user to create a personalized profile, select activities in which the user is interested, and view activities related to those interests within a user-specified radius of the user's current location. By continuously updating the activity information based on the user's present location, certain embodiments ensure that the user receives the most relevant information. For example, even when a person is away from their home city/state/region, he can still view and plan to attend activities that may interest him. For example, someone who enjoys surfing and lives in California, may still see nearby surfing related activities while on vacation in Hawaii, without the need to join any Hawaii specific groups which will be irrelevant to the user once he returns to California.

Another challenge commonly encountered through transitioning from virtual social media interaction to physical activity is the difficulty of selecting those activities that one wishes to attend from a multitude of options. Often, persons may wish to try something new, or wish to expand their social network beyond its current boundaries by meeting people with diverse interests. Accordingly, certain embodiments may, upon registration, automatically or optionally associate a user with a default or wildcard activity. The wildcard activity may provide a user with location-based activities that are either not associated with the specific activities selected by the user, or are not categorized into an existing set of activities. For example, in one embodiment, a user may have selected skiing and snowboarding as relevant activities, but the user may also see culinary activities based on the wildcard activity. By selecting the wildcard activity, users may be provided with new opportunities to participate in activities they may enjoy.

As another example, the wildcard category allows users to create and view events that may not be specifically listed. In this manner the wildcard category may form a “catch all” event category option to allow users to create events for activities that are not specifically referenced in an activity list. Further, the wildcard category allows users to see events that they may be interested in, but that do not fall within a predefined category.

In some embodiments, the wildcard acts as a default activity for all users. In these embodiments, the method helps to ensure that all users will have activities populated in their activity feed. For example, if during the user sign up process, a user does not select any activities, the wildcard automatic selection will populate the user's activity feed with the wildcard activities, helping to prevent a user from having an empty activity feed. As another example, some activities may not have events during certain seasons (e.g., skiing) and in instances where users may only have selected seasonal activities, the wildcard activity group populates the user's activity feed with events that may occur in all seasons so that a user will be able to view events, even out of season with their selected activities.

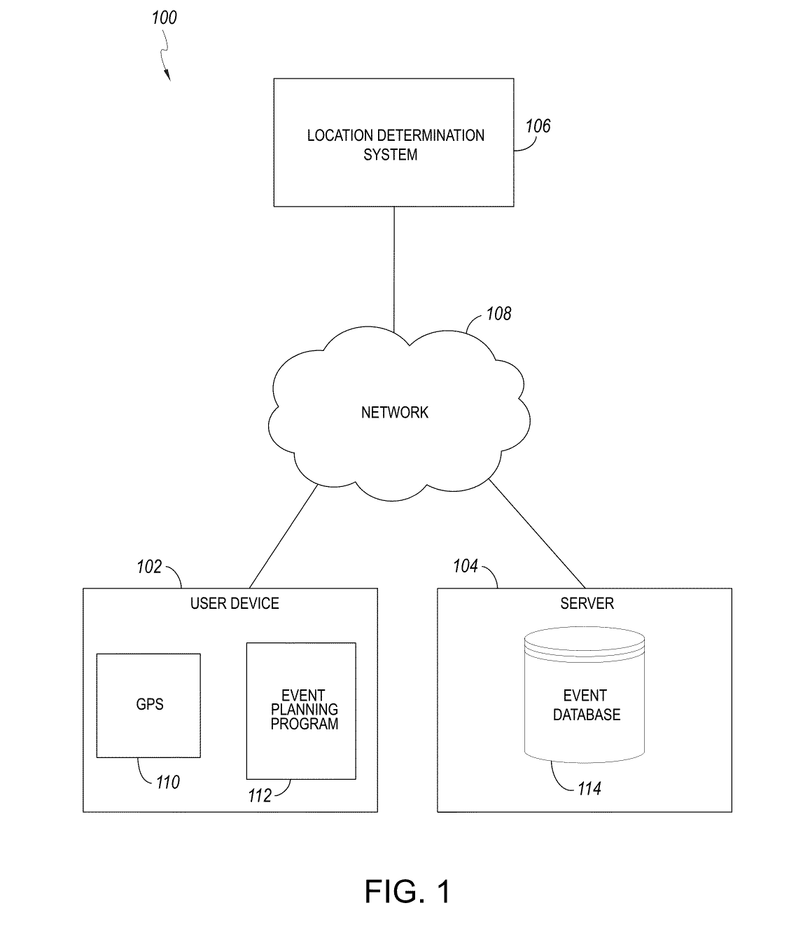

FIG. 1 is a block diagram of a distributed computing system, generally designated 100, including a location-based event planning application 112. The system 100 generally includes a user device 102, a server 104, and a location determination system 106 all connected over a network 108. Network 108 may include connections such as wiring, wireless communication links, fiber optic cables, and any other communication medium. Network 108 may be a wide area network (WAN), such as the Internet, a local area network (LAN), or any other suitable network. In general, network 108 can be any combination of connections and protocols that will support communications between various other devices and computing systems included in the system 100.

In various embodiments, the user device 102 and the server 104 may be desktop computers, laptop computers, tablet computers, smartphones, personal digital assistants, or any other programmable electronic device capable of communicating with the other devices in the system 100 via network 108. In certain embodiments, server 104 may be a computing system utilizing clustered computers and components to act as a single pool of seamless resources when accessed through network 108, as is common in data centers and cloud computing.

The mobile device 102 may include a global positioning system (GPS) 110. The GPS 110 may communicate with the location determination system 106 over the network 108 to determine a location of the user device 102. The location determination system 106 may be any suitable device or combination of devices capable of communicating with the user device 102 and the server 104 over the network 108 to determine the location of the user device 102. The location determination system may include, for example, cellular towers, satellites, or a combination thereof. In some embodiments, the location determination system 106 may include a GPS receiver or other sensors that track the strength and other characteristics of a signal, such as a cellular signal, to determine a location for the user device 102. In embodiments including a GPS receiver, the location determination system 106 may receive data from three or more GPS satellites and then may use the satellite information to determine the location of the user device 102. The location determination system 106 may be configured to determine latitude and longitude information for the user device 102. It should be noted that in many embodiments, the location determination system 106 may use a combination of GPS satellite data and data from other sources, such as Wi-Fi and/or cellular towers. The accuracy, format, and/or precision of the latitude and longitude (or other location data from the location determination system 106) may vary based on the type of user device 102.

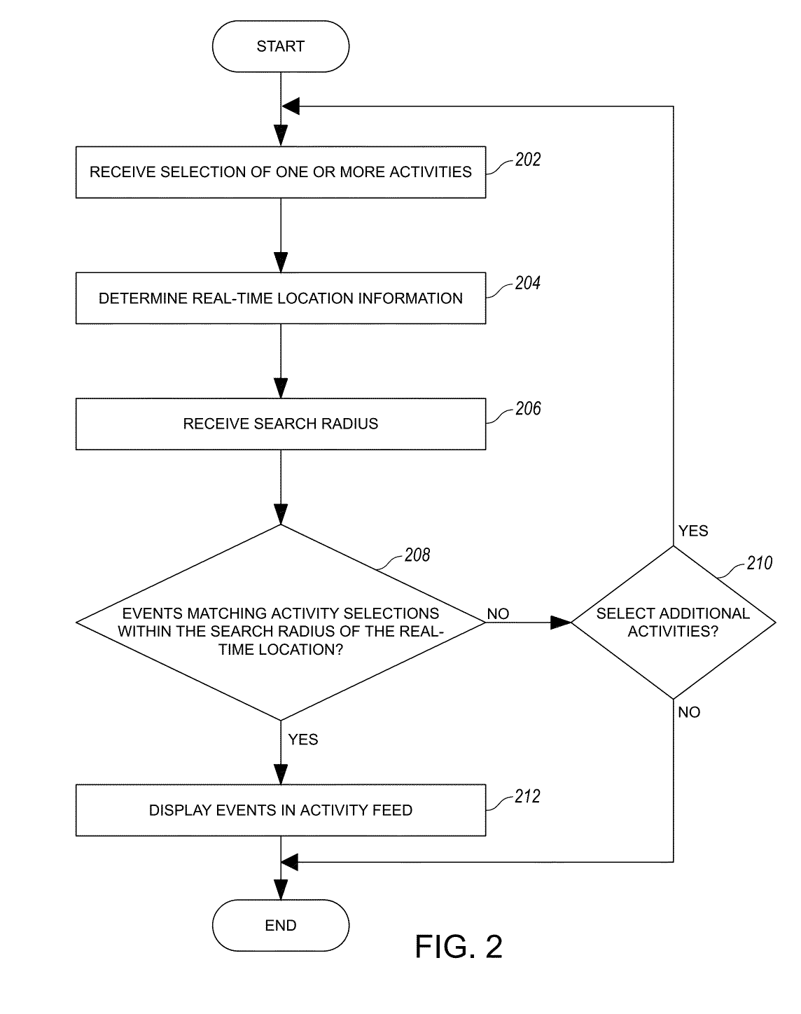

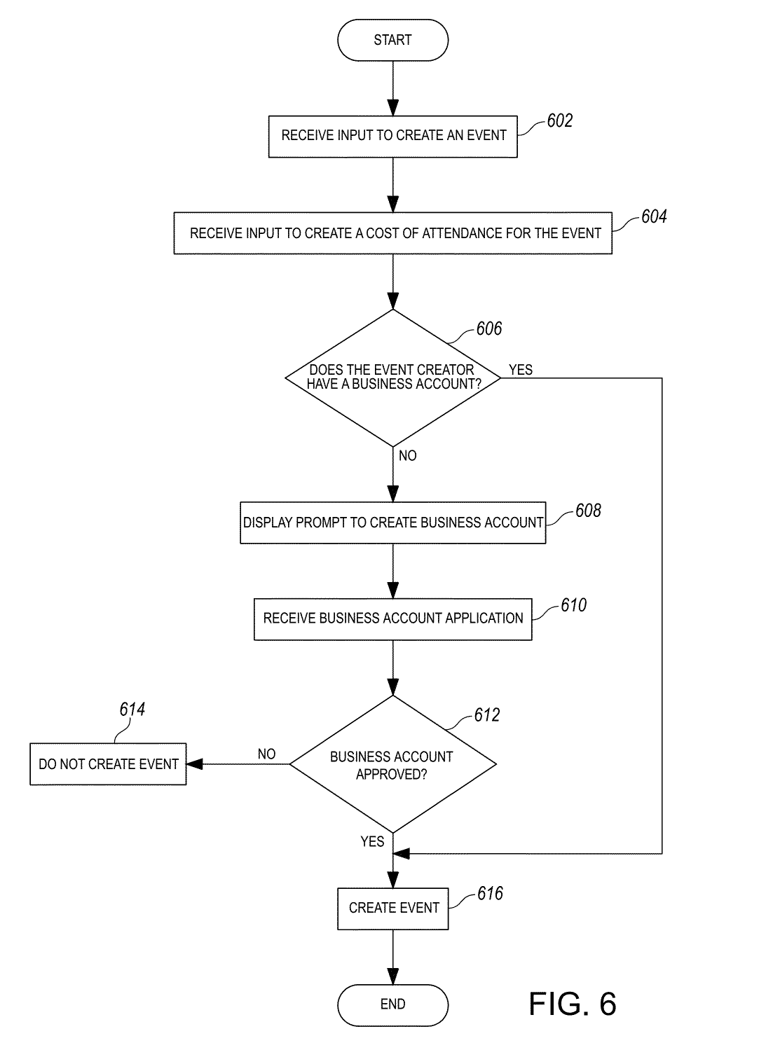

The mobile device 102 may further include an event planning program 112. The event planning program may be configured to use the location information determined by the GPS 110 and the location determination system 106, as well as additional user input, to determine and display a number of upcoming events in which the user may be interested. In various embodiments, the user may save various inputs and preferences. For example, the user may create a login based on an existing social media account or by directly generating login information, such as by creating a unique username and inputting an email or other contact information. In some embodiments, a user can create a unique user name even when logging with another social media account to allow a user to have a specific user name that may or may not be tied to other social media accounts. Alternatively, during the user login in process, the user's email address may be used as the username. Example operations of the event planning program 112 are discussed in further detail below with respect to FIGS. 2-4. Screenshots of an example event planning program 112 are shown in FIGS. 6-20.

The server 104 includes an event database 114. The event database 114 may include a plurality of upcoming events hosted by other users, set up by the system or community contacts or the like. Each event in the event database 114 may include an associated activity tag or tags. The activity tags indicate the generic type of activity associated with the event. For example, the activity tags may indicate activities such as skiing, hiking, biking, rock climbing, etc. Each event may further include a location associated with the event. The location may be indicated in any suitable format, such as a particular address, latitude and longitude information, etc. In some embodiments, the location information may be entered in one format, converted into another format, and indexed based on the second format. For example, a user may enter a street address for an event. The application may then convert the street address into a latitude and longitude, and index the event based upon the latitude and longitude information. In certain embodiments, latitude and longitude may be more convenient and reduce processing overhead when calculating distances between the user and the event location.

In operation, a user of the user device 102 may select one or more activities about which the user would like to receive information, the user selects the one or more activities using an input to the device (e.g., selection through a touch screen, input button, etc.). The user device 102 may determine a location of the user device 102 using the GPS 110 and communicating with the location determination system 106 over the network 108. The user of the user device 102 may also indicate a search radius (e.g., a number of miles, or a travel time) within which the user wishes to view upcoming events. Based on the location information and the search radius, the event planning program 112 via a processing element may access the event database 114 over the network 108 to determine if there are any upcoming events that are associated with the selected activities and within the search radius of the location information of the user device 102. If there are upcoming events that march the user's criteria, then the upcoming activities are displayed to the user on the user device 102. In various embodiments, the location information may be updated periodically, either manually or automatically, to ensure that the user receives event information that is pertinent to the user at that time.

FIG. 2 is a flowchart depicting operations for selecting and displaying events based on real-time location information. In various embodiments, the operations shown in FIG. 2 may be performed, in whole or in part, by the user device 102 though one or more processors executing the event planning program 112. Those skilled in the art will appreciate that, in various embodiments, the operations of the method of FIG. 2 may be performed in a different order than that shown in FIG. 2. Additionally, some embodiments, may include additional or fewer operations than those shown and discussed below.

In operation 202, the event planning program 112 may receive a selection of one or more activities. For example, the user of the user device 102 may select one or more activities using a graphical user interface displayed on the user device 102, through voice controlled entry, or the like. The user may make the selections using any appropriate input means, such as a mouse, keyboard, touchscreen, voice command, etc.

In operation 204, the event planning program 112 determines real-time location information for the user device 102. As discussed above with respect to FIG. 1, the user device 102 may use the GPS 110 to communicate with the location determination system 106 in order to determine the location of the user device 102. The location information is determined in real-time to ensure that the user of the user device 102 is receiving pertinent event information based on the user's actual location. In various embodiments, operation 204 may be updated periodically. For example, the real-time location information may be updated every minute, every 30 minutes, or every hour. Additionally or alternatively, the real-time location information may be manually updated based on a user input. For example, the user may indicate that the event planning program 112 should update the real-time location information by refreshing the activity feed of the event planning program 112.

In operation 206, the event planning program 112 receives a search radius from the user device, which may be entered directly by a user or based on predetermined setting. The search radius may specify a particular distance or travel time within which the user is willing to travel to reach events. A larger search radius may result in more potential events for the user to attend, but the user may have to travel further to reach those events. Accordingly, the user may target his or her search based on the user's ability or desire to travel to events. The event search radius may be specified using any appropriate means, such as a slide bar, manually typed distance, or any other appropriate means. An exemplary event search radius slide bar is shown in FIG. 17. As shown in FIG. 17, the slide bar may have a ball icon, or other graphical feature that may be moved along an axis. The axis may correspond to different event search radii. The slide bar may have a minimum event search radius that may be denoted by one end of the slide bar, and a maximum event search radius that is denoted by the opposite end of the slide bar. In various embodiments, the slide bar may have predetermined gradations between the minimum events search radius and the maximum event search radius. For example, the event search radius may be graduated by miles, half miles, kilometers, or any other suitable unit of distance.

In decision block 208, the event planning program 112 determines whether there are events matching the received activity selections that are within the search radius of the real-time location of the user device 102. The event planning program may access the event database 114 in the server 104 over the network 108. The event planning application may query the event database 114 based on the one or more activities selected by the user in operation 202. The event database 114 may then return a number of events within the selected activities, where each of those events has a location associated with it. The event planning program 112 may then determine the distance between the real-time location of the user device 102 and the event based on the associated event location and the real-time location information determined in operation 204. Next, the event planning program 112 may compare the distance between the user device 102 and the location of the event to the search radius received in operation 206 to determine whether the event location is within the search radius.

If there are no events that match the received activities selection that are also within the search radius (decision block 208, NO branch), then the event planning program 112 determines whether additional activities are to be selected in decision block 210. In decision block 210, the event planning program 112 may display an alert to the user indicating that no events matching the user's criteria were found, and allowing the user to modify the criteria. If the user decides to modify the inputs (decision block 210, YES branch), then the event planning program 112 returns to receive a selection of one or more activities in operation 202. If the user decides not to modify the inputs (decision block 210, NO branch), then the method terminates. In some embodiments, the method of FIG. 2 may continue to update the determination of events based on periodic updates to the real-time location information, despite the user's indication not to alter the input information.

If there are events that match the received activities selection that are also within the search radius (decision block 208, YES branch), then the event planning program 112 may display those events to the user in an activity feed in operation 212.

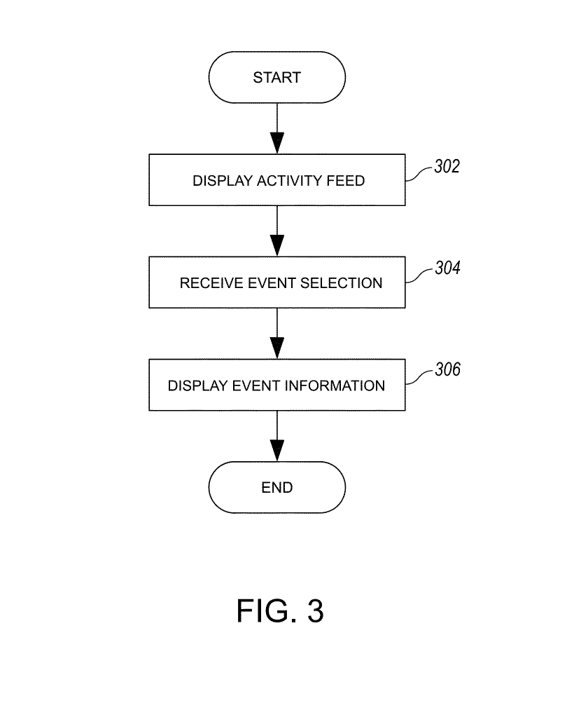

FIG. 3 is a flowchart depicting operations for selecting an event based on real-time location information. In operation 302, the event planning program 112 may display on the user device 102 an activity feed including a number of events matching the user's activity selections and within a search radius of the real-time location of the user device 102. In operation 304, the user may select one or more of the events about which the user wishes to see activity information and upcoming events related to those activities. In operation 306, the event planning program 112 may display event information associated with the selected event.

Each event may include its own event page, which a user may select via a graphical user interface, such as a touchscreen interface. When the user selects an event, the event planning program 112 may display one or more pieces of information associated with the event. Event information may include an event photo(s), event details including time, location, distance from the user (e.g., miles away from the user's current location) and an event description, event creator information, and/or special event information (e.g., length of run, activity skill level required, etc.). In some embodiments, the event may not include a photo at all but instead will display the designated color block assigned for that activity (e.g., the color for the skiing activity type may be light blue). The event page may further include a messaging/chat function for participants to communicate regarding the event. The messaging/chat function enables users to communicate directly with other attendees to the event. The messaging/chat function may be an expandable feature on the event page, or the users may be redirected to a dedicated messaging/chat page for the event. The event page may further include a list of participants intending to attend. That is, the list of participants may include the name and profile picture of each participant. The name of each participant may be a hyperlink that enables a user to select another attendee and view that attendee's profile including, for example, past events that the user has attended. The event page may also include a map showing the location of the event and the option to receive walking/driving/public transportation directions to the event location. The event page may provide a user with the option to join or unjoin the event. Additionally, if the user is the event creator, then the user may optionally edit or delete the event or any piece of event information. Those who have joined the event may receive automatic updates/notifications when the event creator edits or deletes the event. Users may also have the ability to comment on past events or to post photos to the pages of events that they attended.

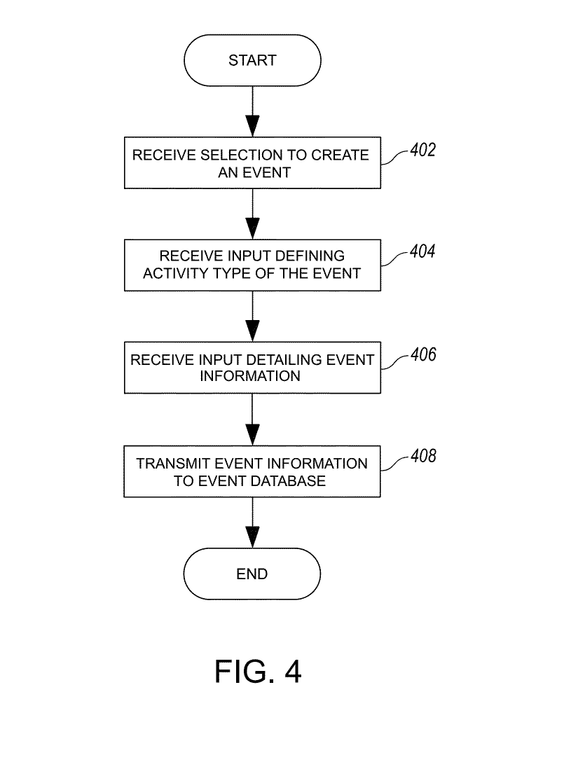

FIG. 4 is a flowchart depicting operations for creating an event using the event planning program 112. The create event option enables a user to generate his or her own event which other people may view, access, and join via their respective activity feeds. In operation 402, the event planning program 112 receives a selection to create an event. The user of the user device 102 may select an option through the graphical user interface or other input to create a new event. In operation 404, the event planning program 112 receives an input defining the activity type of the event. The user may select from a number of predetermined activity types, create a new activity type, or select a catchall, or wildcard, activity type. In various embodiments, the event may be associated with more than one activity type. In operation 406, the event planning program 112 receives an input detailing the event information. The event information includes at least the location of the event. The event information may optionally include additional event information, such as a title, description, pictures, guest list, etc. The user may also select in operation 406 whether the event is public or private, whether to share the event on other social networks, whether the event is a recurring event, and whether there are a maximum number of participants. In operation 408, the event planning program 112 transmits the event to the event database 114 via the network 108. The event may be indexed based on the activity type to allow users to search the event database 114 based on activity type.

The event planning program 112 may include one or more additional features that may be modified by a user of the user device 102. For example, a user may navigate to a menu option via the activity feed. The menu may include various options and/or information related to, among other things, the user's profile, activity filters, application settings, and application information. The menu option may also enable the user to view and/or edit notifications related to the user, such as detail changes to upcoming events, as well as other notifications. The user profile option may allow the user to edit his or her profile, such as personal information, personal photo, etc. The user profile may include a list of activities that the user has selected. when one of the activities in the list of activities is selected, the event planning program 112 may display past events that the user previously attended. The event planning program 112 may access the GPS 110 at the time of the event to determine whether the user is at the location of the event and automatically update the attendance on the event page accordingly. The user may also delete events that the user had previous planned to attend but did not attend. A filter option may allow a user to select/deselect activities that determine which events appear on the user's activity feed. For example, a user may deselect the skiing activity, to remove skiing related activities from the activity feed, and add skydiving in order to see upcoming events related to skydiving. The selection of a particular activity dynamically and automatically filters events on the user's activity feed so that the user is only shown events for activities he or she has chosen.

In some embodiments, users may create connections with other users. Such connections may be unidirectional (where one user gets notifications about the other, but not vice versa) or bidirectional (where both users receive updates about the other). Users may also create groups that may be joined by multiple users. Groups may allow users to create public or private events for members of the group. When a member of a group creates an event, as described above with respect to FIG. 4, the user may select a group to invite to the event. By selecting a single group to which the user belongs, the user creating event may disseminate an invitation to all members of the group. The members of the group may receive a notification of the invitation regardless of whether the event falls within the search radius of the group members at the time the event is created. In this manner, groups may override the location based functionality on a limited basis where the members of the group have elected to join the group and therefore receive event invitations associated with that group regardless of the relative locations of the group members and the event.

The user may also navigate from the menu option to a settings option. The settings option may provide additional control over activities that can affect the activities shown in the activity feed. For example, the user may adjust the search radius within which displayed events must be to show up on the activity feed. For example, a user may be willing to travel further to an event occurring on a weekend than on a weekday, so the user may adjust the event search radius to a larger distance when searching for weekend activities, and readjust the search radius to a smaller distance to search for activities during the week. Finally, the menu option may enable a user to access and review several options related to the location-based event planning application itself, such as help functions, feedback, terms of use, etc. Those skilled in the art will appreciate that the embodiments described above are only example implementations, and the scope of the invention is not limited to those embodiments. Other implementations may be possible without departing from the scope of the present invention. For example, the event planning program 112 may include a global navigation toolbar that can be displayed, for example, at the bottom of a screen of the user device 102. The global navigation toolbar may include selectable icons that, when selected, navigate the user to various other screens and functionality, such as the activity feed, create an event, notifications, search, user profile, etc.

In certain embodiments, an event may be automatically displayed in a user's activity feed if the event is associated with an activity that the user has selected and/or falls within the user's predetermined search radius. In some embodiments, the creator of the event may not be able to control who can see the event or restrict users from subscribing, submitting an RSVP, or receiving notifications surrounding certain activities or events. Accordingly, certain embodiments provide for automatic filtering and display of events outside of the event creator's control, and based on the type of activity involved.

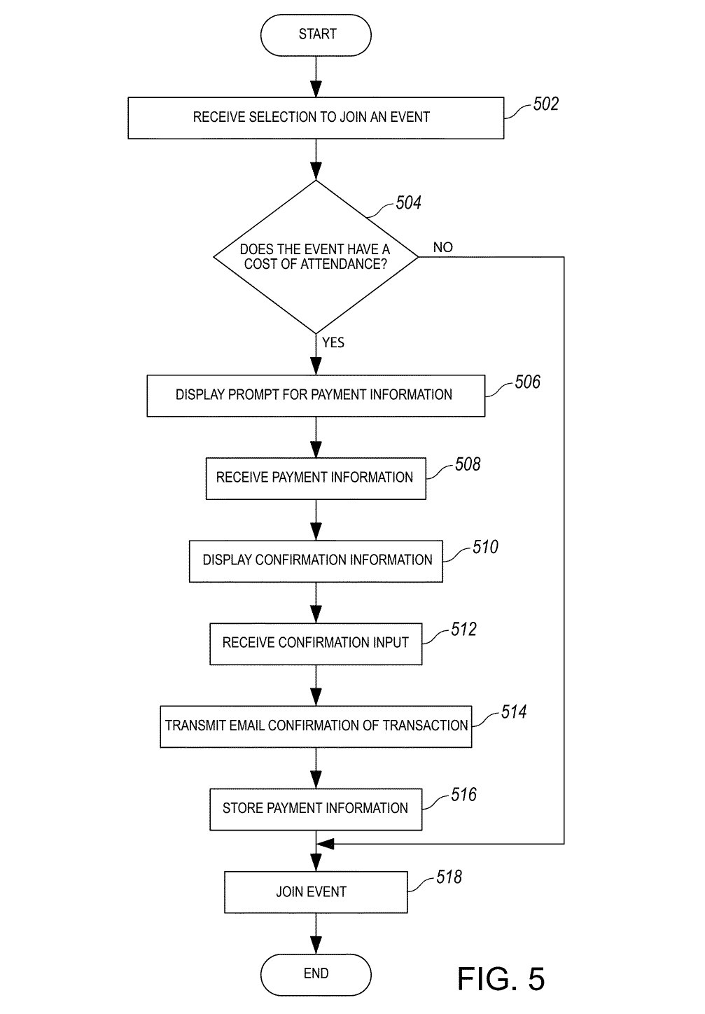

In various embodiments, particular events may have an associated cost of attendance. For example, costs of admission, equipment rental, etc. may be charged up front to participants. FIGS. 5 and 6 provide example embodiments for paying the cost of attendance through the event planning application 112 and creating events with the event planning application 112, respectively. Creating events with an associated cost of attendance may be limited only to users that have a specialized business account. Business accounts may require a monthly fee and the fee may indicate a number of events with a cost of attendance that may be created by the business account holder each month. To establish a business account, a business may provide particular information about the business, which may then be vetted prior to granting the business account. Business account holders may have a specialized interface for creating events and uploading them to the event database 114. For example, business account holders may be able to view the total number of users that have signed up for their events and the total revenue that has been generated by attendees paying the cost of attendance for the business's events. Events created by business account holders may be automatically placed at the top of the activity feed or receive other special indicators and preference in advertising the events to users of the event planning program 112.

FIG. 5 is a flowchart depicting operations for electronically transferring cost of attendance fees through the location based event planning program. In operation 502, the event planning program 112 receives a selection to join an event. The selection to join the event may be provided by a user of the user device 102 by indicating an event in the activity feed to join. In decision block 504, the event planning program 112 determines whether the event has a cost of attendance. Each event stored in the event database 114 may have a field associated with the event entry indicating whether the event has an associated cost of attendance and the particular price that an attendee must pay to attend the event. When the user selects the event, the event planning program 112 may access the event entry in the event database 114 and refer to these fields to determine whether the event has an associated cost of attendance. If the event does not have an associated cost of attendance (decision block 504, NO branch), then the event planning program 112 indicates that the user has joined the event in operation 518.

If the event planning program 112 determines that the event has an associated cost of attendance (decision block 504, YES branch), then the event planning program 112 transmits a prompt for payment information for display in operation 506. The prompt may include one or more fields for the user of the user device 102 to input his or her name, address, and payment information, such as a credit card number. Once the user has input the requested information, the user may submit the information and the event planning program receives the payment information in operation 508. In operation 510, the event planning program 112 transmits confirmation information for display prior to finalizing the payment. The confirmation information enables the user of the user device 102 to review the input information and confirm its accuracy before the payment is processed. Once the user confirms that the information is correct, the user may provide a confirmation input to the event planning program 112 in operation 512. In operation 514, the event planning program 112 transmits an email confirmation of the transaction to the user. The email confirmation may include a receipt for the transaction. In operation 516, the event planning program 112 may store the payment information provided by the user in operation 508. By storing the payment information, the event planning program may process costs of attendance for the user of the user device 102 more quickly in the future. In operation 518, the event planning program 112 indicates that the user of the user device 102 is attending the event that has an associated cost of attendance. The user may then show up on the event page as an attendee of the event, and the user may also have access to and be able to post comments on the event.

FIG. 6 is a flowchart depicting operations for creating an event in a location based event planning program with an associated cost of attendance. In operation 602, the event planning program 112 receives an input from a user to create an event. In operation 604, the event planning program 112 receives an input from the user to create a cost of attendance associated with the event to be created. For example, the user may select a field called “price” which would allow the user to create an event with a cost of attendance. In decision block 606, the event planning program 112 determines whether the user has a business account. The event planning program 112 may access a database containing a list of users that have business accounts as well as the number of events that the user can create that have a cost of attendance. The event planning program 112 may compare the user's credentials to the database to determine whether the user has a business account. If the user has an existing business account (decision block 606, YES branch), then the event planning program 112 creates the event in operation 616. The event may be created as described above with respect to FIG. 4, with the addition of a cost of attendance in the event information provided by the user.

If the event planning program 112 determines that the user does not have a business account (decision block 606, NO branch), then the event planning program 112 transmits for display a prompt to the user to create a business account in operation 608. For example, the prompt may inform the user that events with costs of attendance may only be created by users with business accounts. In response to the displayed prompt, the user may provide various pieces of information about the business, such as the business name and a website. In operation 610, the event planning program 112 receives the provided information. In decision block 612, the event planning program 112 determines whether the business account has been approved. If the business account was not approved (decision block 612, NO branch), then the event is not created by the event planning program 112 in operation 614. If the business account is approved (decision block 612, YES branch), then the event planning program 112 creates the event with the cost of attendance and uploads the event to the event database 114.

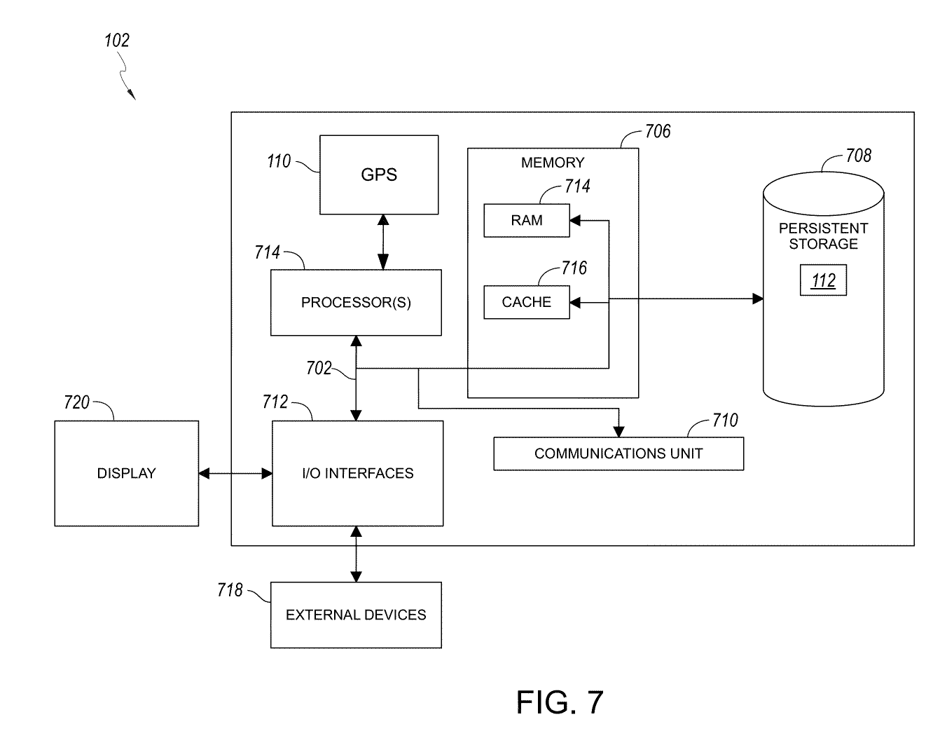

FIG. 7 is a functional block diagram depicting example components of a user device 102 and/or server. In various embodiments, the programmable electronic device may be a laptop computer, a tablet, a smartphone, a gaming device, a personal data assistant (FDA), a desktop computer, or any other suitable programmable electronic device capable of accessing and executing the location based event planning application 112. It should be appreciated that FIG. 7 provides only an illustration of one implementation and does not imply any limitations with regard to the environments in which different embodiments may be implemented. Many modifications to the depicted environment may be made without deviating from the scope of this disclosure.

The programmable electronic device includes communications fabric 702, which provides communications between computer processor(s) 704, GPS 110, memory 706, persistent storage 708, communications unit 710, and input/output (I/O) interface(s) 712. Communications fabric 702 can be implemented with any architecture designed for passing data and/or control information between processors (such as microprocessors, communications and network processors, etc.), system memory, peripheral devices, and any other hardware components within a system. For example, communications fabric 702 can be implemented with one or more buses.

Memory 706 and persistent storage 708 are computer-readable storage media. In this embodiment, memory 706 includes random access memory (RAM) 714 and cache memory 716. In general, memory 706 can include any suitable volatile or non-volatile computer-readable storage media.

The event planning program 112 is stored in persistent storage 708 for execution by one or more of the respective computer processors 704 via one or more memories of memory 706. In this embodiment, persistent storage 708 includes a magnetic hard disk drive. Alternatively, or in addition to a magnetic hard disk drive, persistent storage 708 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 708 may also be removable. For example, a removable hard drive may be used for persistent storage 708. Other examples include optical and magnetic disks, thumb drives, and smart cards that are inserted into a drive for transfer onto another computer-readable storage medium that is also part of persistent storage 708.

Communications unit 710, in these examples, provides for communications with other data processing systems or devices, for example server computing system 104 and server computer 106. In these examples, communications unit 710 includes one or more network interface cards and one or more near field communication devices. Communications unit 710 may provide communications through the use of either or both physical and wireless communications links. Computer programs and processes may be downloaded to persistent storage 708 through communications unit 710.

I/O interface(s) 712 allows for input and output of data with other devices that may be connected to the programmable electronic device. For example, I/O interface 712 may provide a connection to external devices 718 such as a keyboard, keypad, a touch screen, a camera, and/or some other suitable input device. External devices 718 can also include portable computer-readable storage media such as, for example, thumb drives, portable optical or magnetic disks, and memory cards. Software and data used to practice various embodiments can be stored on such portable computer-readable storage media and can be loaded onto persistent storage 708 via I/O interface(s) 712. I/O interface(s) 712 may also connect to a display 720. Display 720 provides a mechanism to display data to a user and may be, for example, an embedded display screen or touch screen.

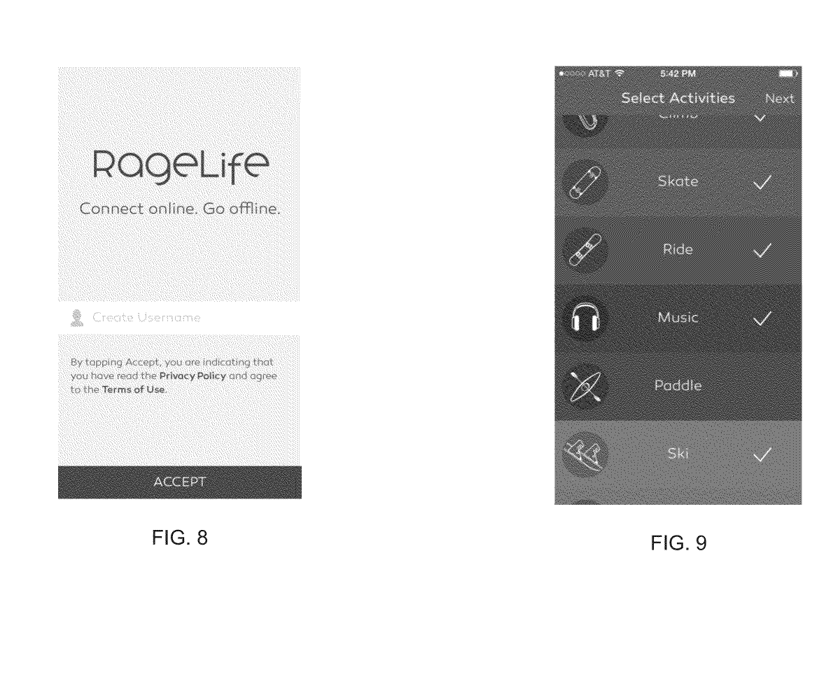

FIGS. 8-24 are example screenshots of a location-based event planning application, in accordance with an exemplary embodiment of the event planning program 112 of FIG. 1.

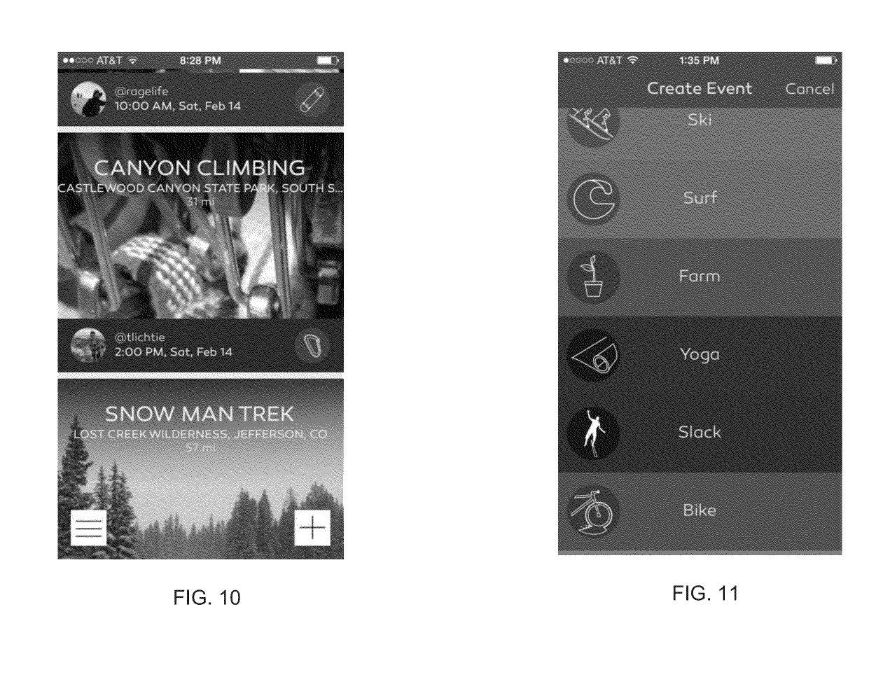

FIG. 8 illustrates an exemplary display of a profile creation screen for the event planning program 112. The profile creation screen may enable a user to select a username to associate with the user's profile. The user can input information directly into the profile, which will then transmit the information to the server that stores the information for use in returning event lists, etc. FIG. 9 illustrates an exemplary activity selection page displayed on the user device 102. The activity selection page may include a number of activities for selection by a user, as described above with respect to operation 202 of FIG. 2. Each activity may have an associated icon and color. The selected activities may have a check mark placed next to the activity. The selected activities may be used to generate queries to the event database 114, as described above in operation 208 of FIG. 2. FIG. 10 illustrates an exemplary activity feed displayed on the user device 102 as described in operation 212 in FIG. 2. The activity feed shown in FIG. 10 may allow a user to view and select events associated with the activities selected on the activity selection page of FIG. 9 that fall within the search radius of the current location of the user device 102.

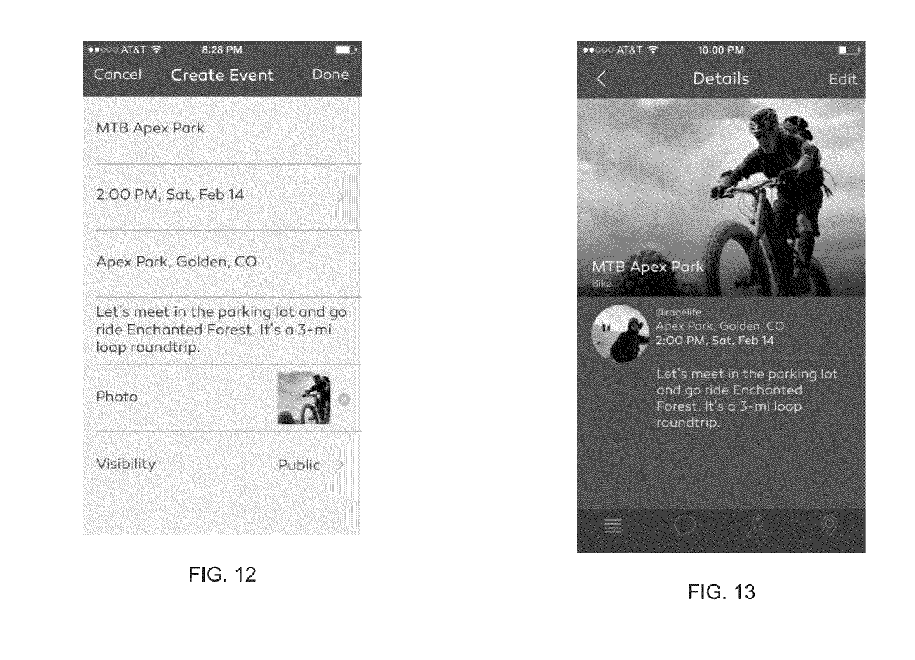

FIG. 11 is an exemplary display of an activity type selection page for event creation, as described above with respect to operation 404 of FIG. 4. A user of the user device 102 may select one of the displayed activity types to create an event associated with that activity type. FIG. 12 is an exemplary display of an event creation screen that allows a user creating an event to enter relevant event information, such as a title, location, time/date, description, photo, and whether the event is public or private.

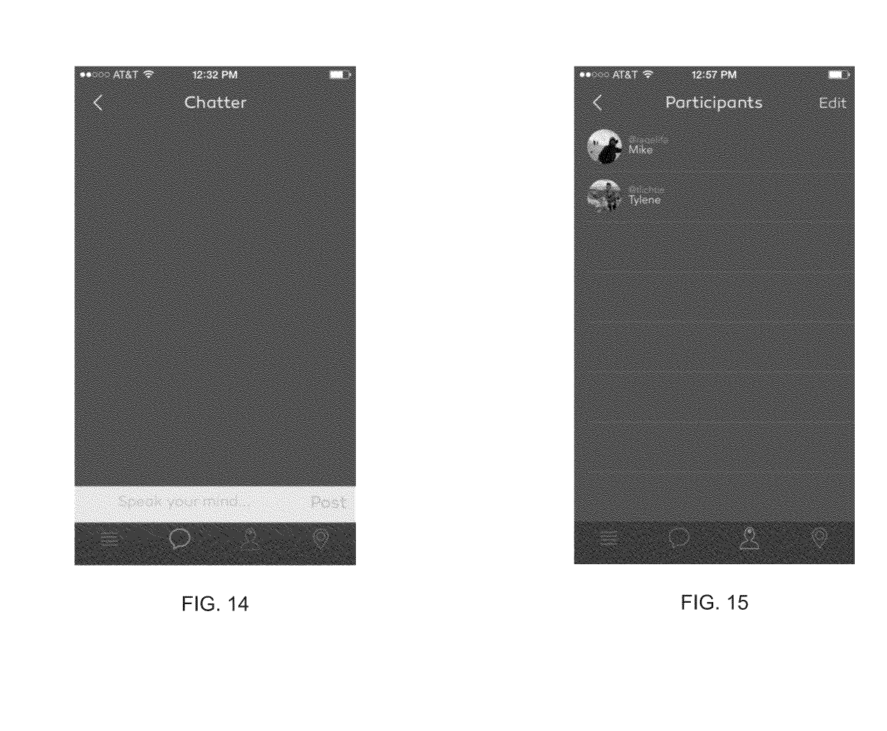

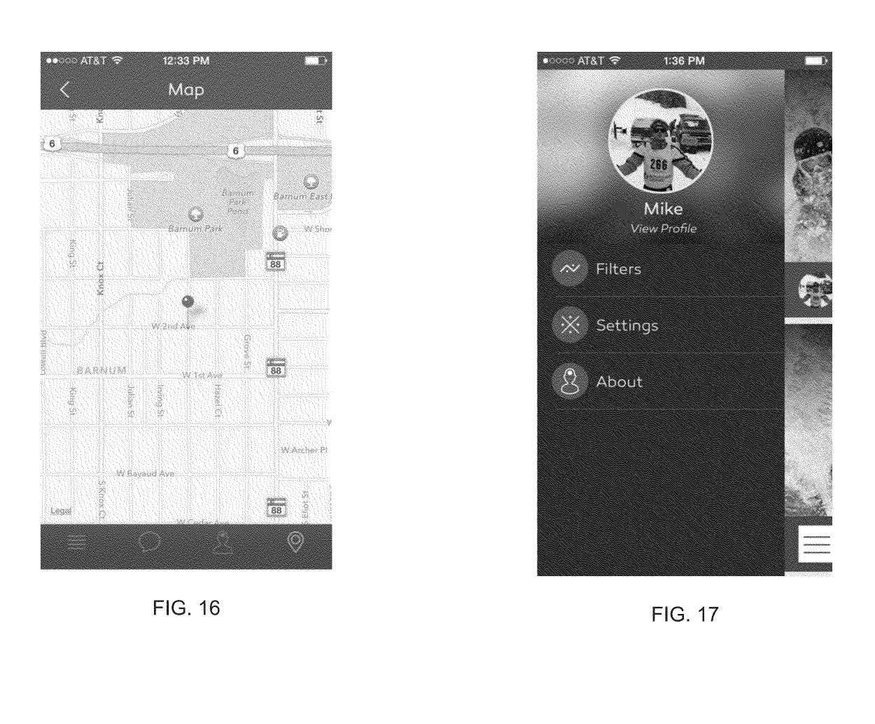

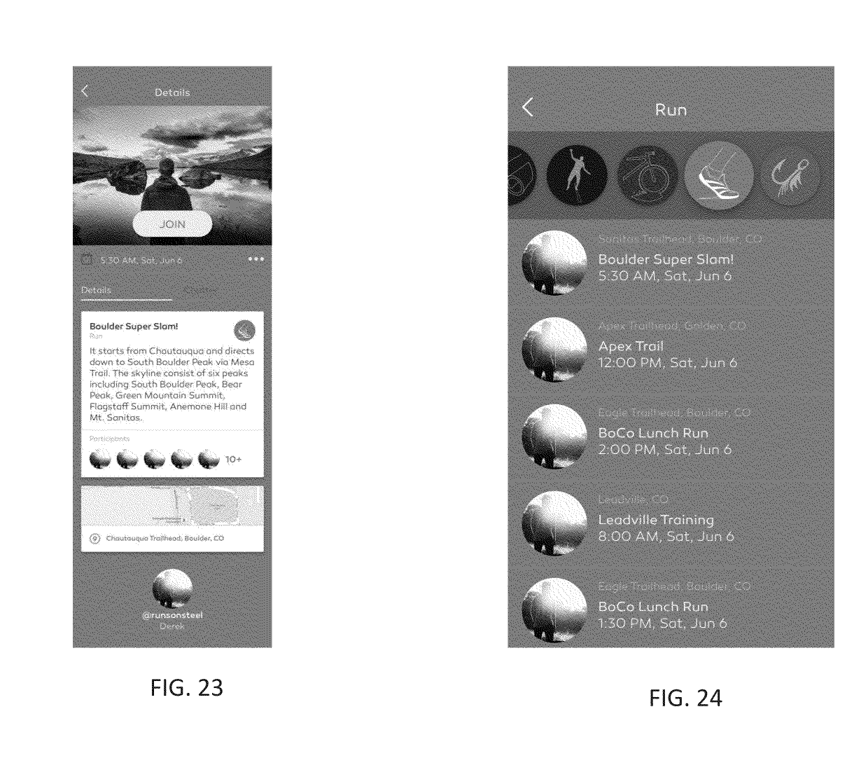

FIG. 13 illustrates an exemplary display of an event page. From the event page of FIG. 13, a user may view the event details, RSVP to the event, view a list of attendees, and chat with other attendees of the event. FIG. 23 illustrates a second exemplary display of an event page. FIG. 14 illustrates an exemplary display of the chat or messaging screen. By typing messages into the box labeled “speak your mind,” users may post messages to the event, as in a message board, so that other attendees to the event may see them, e.g., the messages input by a user are delivered to other users directly or indirectly through the platform. FIG. 15 illustrates an exemplary display of a list of attendees associated with an event. A user may select one of the participants in the list of attendees to view that user's profile, including past events that the user has attended. FIG. 16 illustrates an exemplary display of a map for an event. The map may include an indicator for specifically showing the location that the event is taking place or a meeting location for the event.

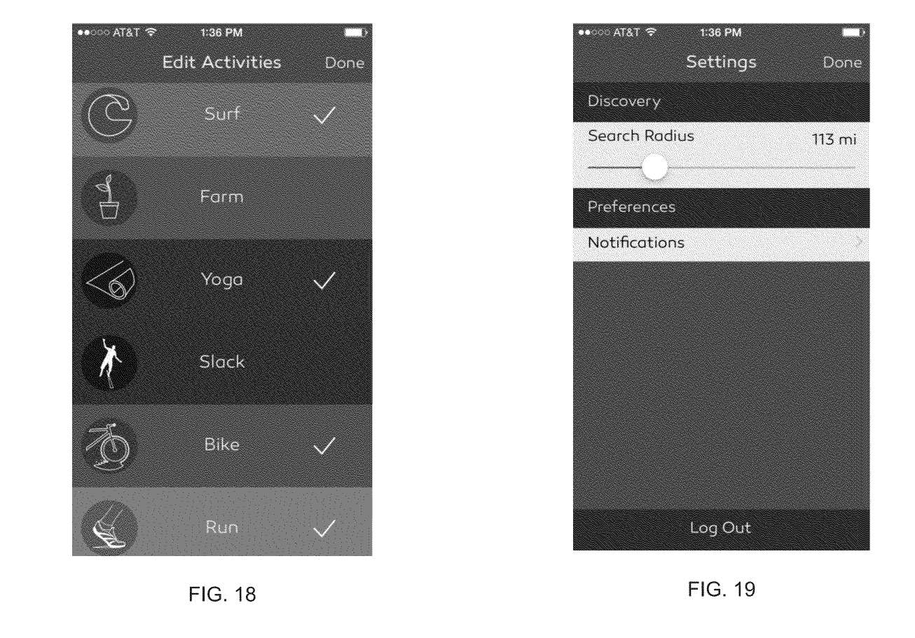

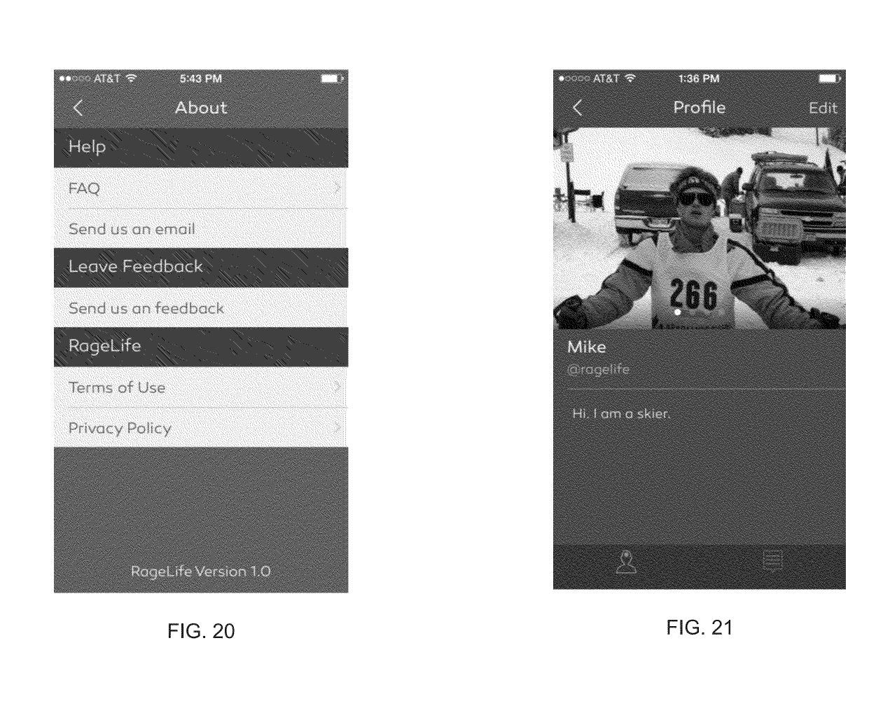

FIG. 17 illustrates an exemplary display of a menu screen of the event planning program 112. In the embodiment of FIG. 17, the user may select the filters option to edit the user's activity selections (as in operation 202 of FIG. 2). FIG. 18 illustrates an exemplary display of an edit activity selections screen. The user may tap or click the various activity categories to select and deselect events within that activity type from appearing on the user's activity feed. Referring again to FIG. 17, the user may also select the settings option to modify user settings such as the search radius (as in operation 206 of FIG. 2). FIG. 19 illustrates an exemplary display of a settings screen. As shown in FIG. 19, the settings screen may include a slider tool for adjusting the search radius. A user may adjust the search radius by moving the icon from one side of the slider tool to the other or anywhere in between. By adjusting the search radius, the events displayed in the activity feed may dynamically update to reflect only activities within the search radius of the current location of the user device 102. The settings screen may also allow users to edit preferences and notification settings. Referring again to FIG. 17, the user may also select the about option to view information on the event planning program 112. FIG. 20 illustrates an exemplary about screen. The about screen may include a help option, a frequently asked questions option, a contact option, terms of use, and privacy information, among other options.

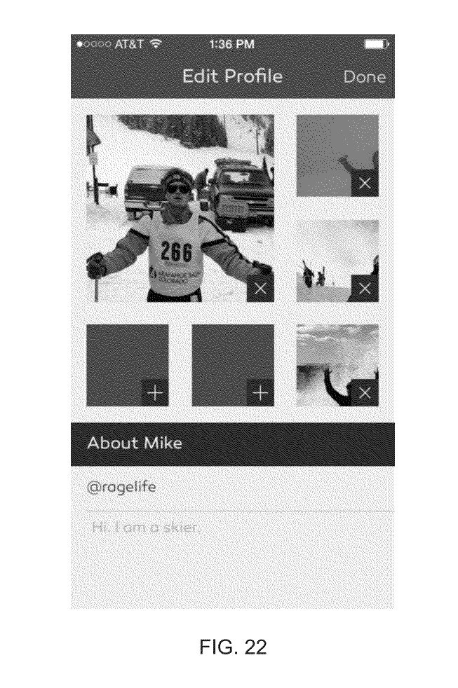

FIG. 21 illustrates an exemplary user profile page. The user profile page may show a profile picture, the user's name, and a description of user. User's may provide as much or little information as desired. FIG. 22 illustrates an exemplary edit user profile display. Through the edit user profile display, a user may change the content of the user's profile. For example, the user may alter the profile photo and the user's description. FIG. 24 illustrates an exemplary event list. A user may select an activity type in a scroll bar across the display. The remainder of the screen may display past and/or future events that the user previously attended and/or plans to attend. The user may also delete events from the display, for example in the event that the user previously indicated an intent to attend, but was unable to do so.

The programs described herein are identified based upon the application for which they are implemented in a specific embodiment. However, it should be appreciated that any particular program nomenclature herein is used merely for convenience, and thus the disclosure should not be limited to use solely in any specific application identified and/or implied by such nomenclature.

The flowchart and block diagrams in the Figures illustrate the architecture, functionality, and operation of possible implementations of systems, methods and computer program products according to various illustrative embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method of organizing events based on real-time location information of a user device comprising:
receiving, by one or more processors, a search radius;
determining, by one or more processors, a current location of a user device based, at least in part, on real-time location information;
receiving, by one or more processors, location information associated with an event specifying a location of the event;
determining, by one or more processors, whether a distance between the current location of the user device and the location of the event exceeds the search radius; and
responsive to determining that the distance between the current location of the user device and the location of the event does not exceed the search radius, transmitting information associated with the event to be displayed on the user device.

2. The method of claim 1, wherein determining the current location of the user device comprises:
accessing, by the one or more processors, a global positioning system in communication with the user device;
receiving, by the one or more processor, the real-time location information from the global positioning system.

3. The method of claim 2, wherein the global positioning system determines the real-time location information using associated global positioning system satellites.

4. The method of claim 2, wherein the global positioning system determines the real-time location information using one or more cellular towers.

5. The method of claim 1, further comprising:
receiving by one or more processors a selection of one or more activity types, wherein the event is associated with at least one of the one or more activity types.

6. The method of claim 5, further comprising:
transmitting a query to a database, wherein the database includes a plurality of events indexed by activity type, and the query is based on the one or more activity types.

7. The method of claim 6, wherein the database further includes the location information associated with the event.

8. The method of claim 1, wherein the displayed information is color coded based on an activity type of the event.

9. The method of claim 1, wherein the real-time location information is automatically updated periodically.

10. The method of claim 9, wherein the displayed information associated with the event is automatically updated based on the automatically updated real-time location information.

11. A method displaying events based on real-time location information comprising:
receiving, from a database, a plurality of events, each event in the plurality of events having an event location;
determining, by one or more processors, whether the event location of each event in the plurality of events is within a search radius, wherein the search radius is centered on a current location of a user device; and
responsive to determining that a first event location is within the search radius, transmitting data corresponding to a first event associated with the first event location to the user device for display.

12. The method of claim 11, the plurality of events is associated with a first activity type.

13. The method of claim 12, further comprising:
responsive to determining that no event locations associated with the events in the plurality of events are within the search radius, receiving a second plurality of events from the database, wherein the second plurality of events is associated with a second activity type;
determining, by the one or more processors, whether an event location of each event in the second plurality of events is within the search radius.

14. The method of claim 11, wherein the search radius is specified by a user input.

15. The method of claim 11, further comprising:
determining the current location of the user device based on a global positioning system associated with the first user device.

16. The method of claim 15, wherein the current location is automatically updated periodically.

17. The method of claim 15, wherein the global positioning system includes one or more satellites.

18. The method of claim 15, wherein the global positioning system includes one or more cellular towers.

19. The method of claim 11, wherein determining whether the event location of each event in the plurality of events is within the search radius comprises:
determining a distance between the current location of the user device and the event location; and
determining whether the distance is less than the search radius.

20. A method of providing payment through a location based event planning program comprising:
receiving a selection by a user device to join an event, wherein the event is taking place within a user specified radius of a current location of the user device;
transmitting, over a network, a query to a database to determine whether the event has an associated cost of attendance;
responsive to determining that the event has an associated cost of attendance, transmitting a prompt on the user device to request payment information;
receiving payment information from the user device;
responsive to verifying that the received payment information is valid, storing the payment information in association with a user profile; and
adding the user profile as an attendee to the event.
